(19) United States
(12) Patent Application Publication
(10) Pub. No.: US 2017/0039552 A1
(43) Pub. Date: Feb. 9, 2017

(54) SYSTEMS, METHODS AND DEVICES FOR PROVIDING A SINGLE-USE PAYMENT CREDENTIAL

(71) Applicant: Visa International Service Association, San Francisco, CA (US)

(72) Inventors: Alan Joseph O'Regan, Cape Town (ZA); Horatio Nelson Huxham, Cape Town (ZA)

(21) Appl. No.: 15/303,204

(22) PCT Filed: Apr. 29, 2015
(86) PCT No.: PCT/IB2015/053100

§ 371 Date: Oct. 10, 2016

(30) Foreign Application Priority Data
Apr. 30, 2014 (ZA) 2014/03131

(51) Int. Cl. G06Q 20/38; G06Q 20/32; G06Q 20/40

(52) U.S. Cl. CPC G06Q 20/385; G06Q 20/40; G06Q 20/3821; G06Q 20/325

(57) ABSTRACT

Systems, methods and devices for providing a single-use payment credential usable in a financial transaction are disclosed. In a method conducted at a remotely accessible server, a request for a single-use payment credential is received from an issuing financial entity. The request includes a consumer identifier of a consumer. The server associates the consumer identifier with a single-use payment credential in a database and transmits the single-use payment credential to a communication device of the consumer for presentation to a merchant. The server receives a transaction request including the single-use payment credential from an acquiring financial entity and transmits an indication of the transaction request in respect of the consumer identifier to the issuing financial entity such that the financial transaction may be completed.

### CROSS REFERENCE(S) TO RELATED APPLICATIONS

This application claims priority to South African provisional patent application number 2014/03131 filed on 30 Apr. 2014, which is incorporated by reference herein.

### FIELD OF THE INVENTION

This invention relates to systems, methods and devices for providing a single-use payment credential.

### BACKGROUND TO THE INVENTION

In some developing regions, many consumers may be ‘unbanked’ meaning that they do not have conventional financial accounts at brick-and-mortar financial institutions. This may be as a result of brick-and-mortar financial institutions being few and far between with associated financial infrastructure such as automatic teller machines (ATMs) being scarce as well.

Mobile communication networks, however have become prevalent in many developing regions with many consumers making use of communication devices such as mobile phones. Some mobile network operators provide mobile banking facilities to consumers which may allow such unbanked or under-banked consumers to use their communication devices to access financial services.

One example of such a mobile banking facility may include a consumer, having a communication device, and an issuing financial entity, having a value store containing a plurality of consumer accounts therein. The issuing financial entity may provide a direct mobile communications channel between itself and the consumer to enable the consumer to transact against a consumer account held at the value store via the mobile communications channel. In some implementations and particularly in developing markets, the issuing financial entity may be a mobile money operator, typically a bank or a mobile network operator, providing a mobile money platform to enable the consumer to transact against the consumer account using his or her mobile device.

In some implementations of mobile banking facilities, the issuing financial entity may request single-use payment credential from a gateway entity on behalf of a consumer. The received single-use payment credential may then be transmitted to a mobile device of the relevant consumer for use in a transaction.

A problem with an implementation such as the above is that the issuing financial institutions may receive single-use payment credential which are destined for consumers. Given the sensitive nature of single-use payment credential, the issuing financial institution may need to meet stringent requirements for storing or handling single-use payment credential imposed by, for example, the Payment Card Industry Data Security Standard (PCI DSS) and other controlling bodies or organizations. Having to meet these requirements may impose an unnecessary burden on issuing financial institutions.

A further problem which may be associated with such mobile banking facilities is that the mobile communications channel between the financial entity having a value store and the consumer may not have a desired level of security. For example, in cases where the entity having a value store is a bank or a mobile money operator, single-use payment credential or other financial information may be transmitted from the bank or mobile money operator to the mobile device of the consumer “in the clear”, thereby increasing the risk of fraudulent activities such as man-in-the-middle attacks.

Embodiments of the invention aim to address these and/or other problems at least to some extent.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with a first aspect of the invention, there is provided a method of providing a single-use payment credential usable in a financial transaction, the method conducted at a remotely accessible server comprising the steps of: receiving, from an issuing financial entity, a request for a single-use payment credential, the request including a consumer identifier of a consumer; associating, in a database, the consumer identifier with a single-use payment credential; transmitting the single-use payment credential to a communication device of the consumer for presentation to a merchant; receiving, from an acquiring financial entity, a transaction request including the single-use payment credential; and, transmitting an indication of the transaction request in respect of the consumer identifier to the issuing financial entity such that the financial transaction may be completed.

Thus, the single-use payment credential is not transmitted to the communication device via the issuing financial entity.

A further feature provides for the step of receiving a request for a single-use payment credential to be responsive to the issuing financial entity receiving, from a communication device of a consumer, a request for a single-use payment credential.

Yet further features provide for the single-use payment credential to be usable only in combination with a verification value and for the step of transmitting the single-use payment credential to a communication device of the consumer to transmit the verification value to the communication device of the consumer in a first message and the single-use payment credential to the communication device of the consumer in a second message, and for the first and second message to be transmitted to the communication device of the consumer separately.

A still further feature provides for the step of associating the consumer identifier with a single-use payment credential to include steps of: generating or obtaining a single-use payment credential; and, associating the generated or obtained single-use payment credential with the consumer identifier in a database.

A further feature provides for the step of receiving a transaction request including the single-use payment credential from an acquiring financial entity further to include receiving a verification value in the transaction request.

A yet further feature provides for the step of receiving a transaction request including the single-use payment credential and the verification value from the acquiring financial entity to include steps of: using the received single-use payment credential to query the database to obtain the consumer identifier associated with the single-use payment credential; and, comparing the received verification value with a verification value stored in the database in association with the consumer identifier so as to authenticate the transaction request.

A still further feature provides for the method to include initial registration steps of: receiving a consumer registration request from an issuing financial entity, the registration request including a consumer identifier; associating the consumer identifier with a verification value; and, transmitting the verification value to the communication device of the consumer. The verification value may be static.

In accordance with a second aspect of the invention there is provided a system for providing a single-use payment credential usable in a financial transaction, the system comprising a remotely accessible server including: a request receiving component for receiving, from an issuing financial entity, a request for a single-use payment credential, the request including a consumer identifier of a consumer; an associating component for associating, in a database, the consumer identifier with a single-use payment credential; a payment credential transmitting component for transmitting the single-use payment credential to a communication device of the consumer for presentation to a merchant; a payment credential receiving component for receiving, from an acquiring financial entity, a transaction request including the single-use payment credential; and, an indication transmitting component for transmitting an indication of the transaction request in respect of the consumer identifier to the issuing financial entity such that the financial transaction may be completed.

A further feature provides for the system further to include an issuer processor maintained or operated by an issuing entity and having: a receiving component for receiving, from the communication device, a request, including a consumer identifier, for a single-use payment credential; a transmitting component for transmitting the request for a single-use payment credential to the remotely accessible server; and, an indication receiving component for receiving an indication of the transaction request in respect of the consumer identifier from the remotely accessible server.

A yet further feature provides for the system further to include a communication device having: a request transmitting component for transmitting a request for a single-use payment credential to the issuing entity; and, a payment credential receiving component for receiving the single-use payment credential from the remotely accessible server.

Further features provide for the remotely accessible server to include a generating component for generating or obtaining a single-use payment credential, and for the associating component to be for associating the generated or obtained single-use payment credential with the consumer identifier in a database.

A yet further feature provides for the payment credential receiving component to receive, from an acquiring financial entity, a transaction request including the single-use payment credential and a verification value.

A still further feature provides for the remotely accessible server to include: a querying component for querying the database using the received single-use payment credential to obtain the consumer identifier associated with the single-use payment credential; and, a comparing component for comparing the received verification value with a verification value stored in the database in association with the consumer identifier so as to authenticate the transaction request.

A yet further feature provides for the system to include a registration component for: receiving a consumer registration request from an issuing financial entity, the registration request including a consumer identifier; associating the consumer identifier with a verification value; and, transmitting the verification value to the communication device of the consumer. The verification value may be static.

Further features provide for the remotely accessible server to include a mobile communication component which enables the remotely accessible server to communicate with the communication device via a mobile communication network, and for the payment credential transmitting component to transmit the single-use payment credential to a communication device of the consumer via the mobile communication component.

In accordance with a third aspect of the invention, there is provided a computer program product for providing a single-use payment credential usable in a financial transaction, the computer program product comprising a computer-readable medium having stored computer-readable program code for performing the steps of: receiving, from an issuing financial entity, a request for a single-use payment credential, the request including a consumer identifier of a consumer; associating, in a database, the consumer identifier with a single-use payment credential; transmitting the single-use payment credential to a communication device of the consumer for presentation to a merchant; receiving, from an acquiring financial entity, a transaction request including the single-use payment credential; and, transmitting an indication of the transaction request in respect of the consumer identifier to the issuing financial entity such that the financial transaction may be completed.

Further features provide for the computer-readable medium to be a non-transitory computer-readable medium and for the computer-readable program code to be executable by a processing circuit.

### BRIEF DESCRIPTION OF THE DRAWINGS

The invention will now be described, by way of example only, with reference to the accompanying representations in which:

FIG. 1 is a schematic diagram which illustrates a known system according to the prior art;

FIG. 2 is a schematic diagram which illustrates a system for providing a single-use payment credential according to embodiments of the present invention;

FIG. 3 is a block diagram which illustrates components of devices of a system for providing a single-use payment credential according to embodiments of the invention;

FIG. 4A is a swim-lane flow diagram which illustrates methods for providing a single-use payment credential according to embodiments of the invention;

FIG. 4B is a swim-lane flow diagram which illustrates methods for providing a single-use payment credential according to embodiments of the invention;

FIG. 5 is a flow diagram which illustrates an example of a method for providing a single-use payment credential according to embodiments of the invention;

FIG. 6 illustrates an example of a mobile communication network on which aspects of the disclosure may be implemented;

FIG. 7 illustrates an example of a computing device in which various aspects of the disclosure may be implemented; and,

FIG. 8 shows a block diagram of a communication device that may be used in embodiments of the disclosure.

### DETAILED DESCRIPTION WITH REFERENCE TO THE DRAWINGS

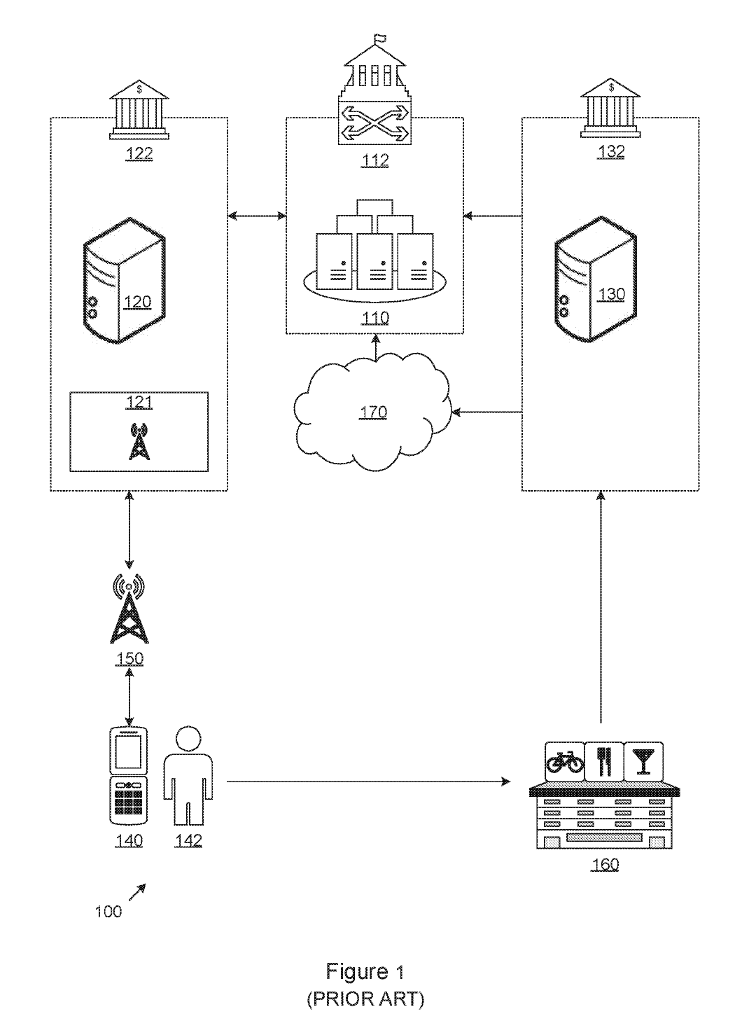

FIG. 1 is a schematic diagram which illustrates a known system (100) according to the prior art. The system (100) includes a remotely accessible server (110), an issuer processor (120), an acquirer processor (130), a communication device (140) and a mobile communication network (150). The remotely accessible server (110) may be maintained or operated by a gateway entity (112). The issuer processor (120) and acquirer processor (130) may be operated by an issuing financial entity (122) and an acquiring financial entity (132) respectively. The communication device (140) may be operated by a consumer (142). The communication device (140) is in communication with the issuer processor (120) via the mobile communication network (150). The known system (100) may also include a merchant (160) and a payment processing network (170). The issuer processor (120) and acquirer processor (130) are in communication with the remotely accessible server (110) via another communication network.

The issuing financial entity (122) of the known system (100), has a value store containing a plurality of consumer accounts therein. The issuing financial entity (122) may have a mobile communication component (121) which allows the issuing financial entity (122) to utilize a mobile communication channel (150) to enable the consumer (142) to transact against a consumer account held at the value store via the communication device (140) and the mobile communications channel (150). The issuing financial entity (122) may be a mobile money operator, typically a bank or a mobile network operator, providing a mobile money platform to enable the consumer (142) to transact against the consumer account using his or her communication device (140). For example, the consumer (142) may make use of a single-use payment credential to transact against the consumer account.

A single-use payment credential as used herein may include a primary account number (PAN), a bank identification number (BIN) and possibly an expiry date. As such, a single-use payment credential may be capable of being used to route a transaction request to an appropriate consumer account of a consumer. Single-use payment credentials typically have a time-to-live, such as for example, 10 minutes. After expiry of the time-to-live, the single-use payment credential may become invalid. In other cases, single-use payment credential as used herein may be any appropriate payment token which is communicated to a consumer's communication device and is usable to conduct a transaction against a financial account of the consumer.

The known system (100) is configured to permit the consumer (142) to request a single-use payment credential from the issuing financial entity (122). Upon receiving this request, the issuing financial entity (122) of the known system (100) is configured to request a single-use payment credential from the gateway entity (112) on behalf of the consumer (142). In response, the gateway entity (112) is configured to transmit a single-use payment credential to the issuing financial entity (122). The single-use payment credential is received at the issuing financial entity (122) from the gateway entity (112) and may then be transmitted from the issuing financial entity (122) to the consumer (142) via the mobile communication network (150) and the communication device (140) of the consumer.

The consumer (142) may then use the single-use payment credential in a transaction, for example, by presenting the single-use payment credential to a merchant (160). The merchant (160) may then transmit a transaction request including the single-use payment credential to an acquiring financial entity (132). The acquiring entity may transmit the transaction request including the single-use payment credential to the gateway entity (112) possibly via the payment processing network (170). The transaction request including the single-use payment credential will be received at the issuing financial institution such that the transaction may be completed.

The single-use payment credential is typically transmitted from the issuing financial entity (122) to the consumer (142) in the clear. This may make the single-use payment credential susceptible to interception by unauthorized third parties. Such unauthorized third parties may be able to make use of the intercepted single-use payment credential to transact fraudulently against a consumer account without the consumer's knowledge.

Another problem with the known system (100) of the prior art described above is that the issuing financial institution (122) receives the single-use payment credential which is destined for the consumer (142). The single-use payment credential contains sensitive information which, if intercepted, could be used fraudulently to transact against a consumer's account. Even though the payment credential is valid for a limited time only, there remains a window in time in which the single-use payment credential may be intercepted and fraudulently used by miscreants. In order to mitigate this fraud risk, the issuing financial institution (122) may be required to meet stringent requirements for storing or handling payment credentials (such as single-use payment credentials) imposed by, for example, the Payment Card Industry Data Security Standard (PCI DSS) and other controlling bodies or organizations. Having to meet these requirements may impose a financial and compliance burden on the issuing financial institution (122). This may be the case particularly in mobile banking facilities in which the issuing financial entity (122) is a mobile money operator, or even more specifically, a mobile network operator, who would not otherwise need to be PCI DSS compliant. Such a requirement may hinder the adoption by mobile network operators of mobile banking facilities, which may in turn reduce ease-of-access by the unbanked to basic financial services.

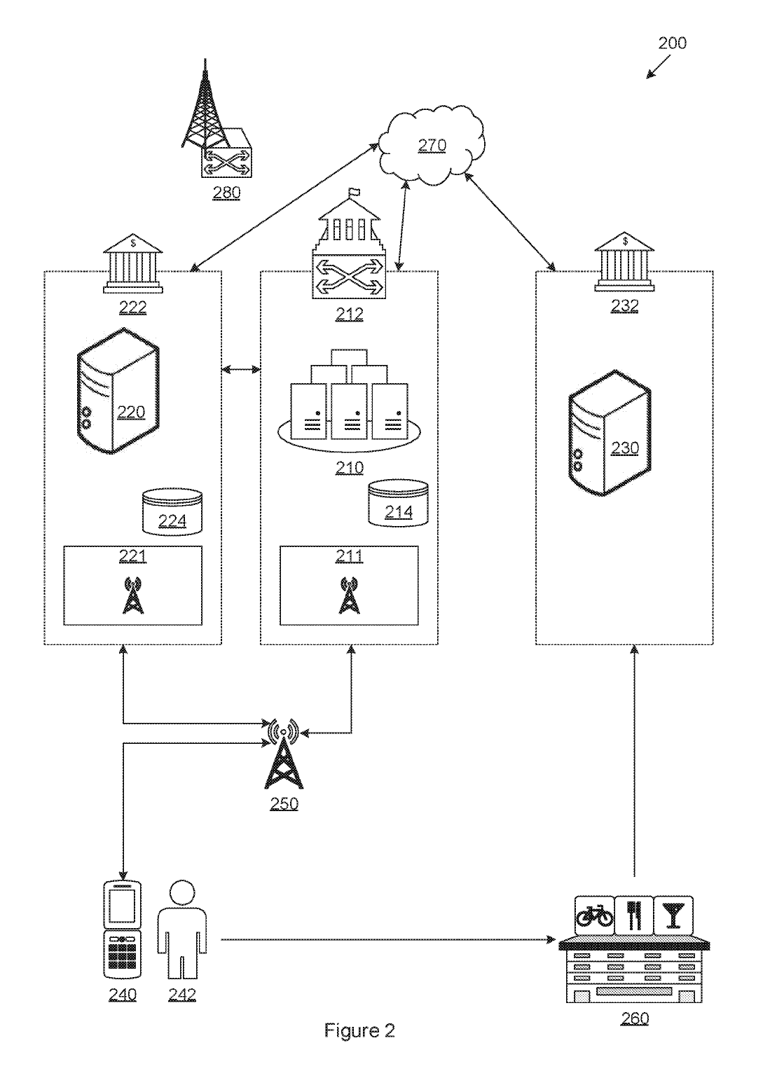

These problems are addressed, at least to some extent, by embodiments of the present invention. FIG. 2 is a schematic diagram which illustrates a system (200) according to embodiments of the present invention.

The system (200) includes a remotely accessible server (210), an issuer processor (220), an acquirer processor (230), a communication device (240) and a mobile communication network (250). The system (200) may also include a merchant (260) and a payment processing network (270).

The issuer processor (220) may be maintained or operated by an issuing financial entity (222). In some cases, the issuing financial entity (222) may be a mobile money operator, such as a mobile network operator providing basic financial services to its subscribers. It is also anticipated that the issuing financial institution (222) and the acquiring financial institution (232) may be the same financial institution which may perform the operations of both institutions (222, 232).

The issuer processor (220) may have access to a database (224) and a mobile communication component (221) by way of which the issuer processor (220) can communicate with the communication device (240). The mobile communication component (221) may provide one or more of: a short messaging service (SMS), unstructured supplementary services data (USSD), and an extensible hypertext mark-up language (xHTML) channel configured for inbound and outbound communication with the communication device (240).

The database (224) may have a value store and a plurality of consumer accounts therein. The issuing financial entity (222) may accordingly be configured to receive a registration request form the communication device (240) of the consumer (242). The registration request may be received form the communication device (240) via a USSD session established by the communication device (240) with the issuing financial entity (222). The issuing financial entity (222) may create a consumer account in association with the consumer identifier and may also transmit the registration request to the remotely accessible server (210).

The issuing financial entity (222) may further be configured to receive a request for a single-use transaction from the communication device (240). The registration request may be received form the communication device (240) via a USSD session established by the communication device (240) with the issuing financial entity (222).

The issuing financial entity (222) may then be configured to transmit the request for a single-use payment credential to the remotely accessible server (210). The issuing financial entity (222) may be configured to receive, at a later stage, an indication of a transaction request from the remotely accessible server (210) such that the issuing financial entity (222) may complete the transaction, for example, by deducting a value, corresponding to a transaction value included in the transaction request, from the consumer account corresponding to the consumer identifier associated with the transaction request.

The remotely accessible server (210) may be maintained or operated by a gateway entity (212). A gateway entity (212) may be an entity providing switching and/or interoperability in a mobile money ecosystem. A gateway entity (212), for example, may enable payments from one mobile money platform (operated by a first mobile money operator) to another mobile money platform (operated by a second mobile money operator). In some cases, a gateway entity (212) may be associated with or a part of an entity (e.g. Visa®) providing the payment processing network (270) (e.g. VisaNet™).

The remotely accessible server (210) may be any appropriate server computer, distributed server computer, cloud based server computer or the like. The remotely accessible server (210) may have access to a database (214) in which data and information can be stored and associated with records and from which data and information can be retrieved. The remotely accessible server (210) and database (214) may be implemented in a manner which complies with, for example, PCI DSS such that data and information stored and handled by the remotely accessible server (210) and database (214) is secure and not susceptible to unauthorized access. For example, one or both of the remotely accessible server (210) and database (214) may be implemented within a hardware security module in order to achieve the required data security standards.

Furthermore, the remotely accessible server (210) may have a mobile communication component (211) to enable the remotely accessible server (210) to communicate with the communication device (240) of the consumer (242) via the mobile communication network (250). The mobile communication component (211) may provide one or more of: an SMS, USSD, and xHTML channel configured for inbound and/or outbound communication with the communication device (240).

The remotely accessible sever (210) may be in communication with the issuing financial entity (222) via, for example, the payment processing network (270) and/or another appropriate network infrastructure, such as the Internet (280), and may be configured to receive a consumer registration request from the issuing financial entity (222). The registration request may include a consumer identifier. In response, the remotely accessible server (210) may be configured to associate the consumer identifier with a verification value. The verification may be generated or obtained by the remotely accessible server (210) and associated with the consumer identifier in the database (214). The remotely accessible server (210) may be further configured to transmit the verification value via the mobile communication network to the communication device (240) of the consumer (242). In some embodiments, the verification value may be static and stored in a digital memory of the communication device (240) for subsequent use. The verification value may be transmitted to the communication device (240) as an SMS message. In other embodiments, the verification value may be transmitted to the communication device (240) using interactive voice response (IVR).

Furthermore, the remotely accessible server (210) may be configured to receive, from the issuing financial entity (222), a request for a single-use payment credential. The request may include the consumer identifier of the consumer (242). The remotely accessible server (210) may be configured to associate the consumer identifier with a single-use payment credential. In some embodiments, this may involve generating or obtaining a single-use payment credential and associating the generated or obtained single-use payment credential with the consumer identifier in the database (214).

The remotely accessible server (210) may be further configured to transmit the single-use payment credential to the communication device (240) of the consumer (242). The single-use payment credential may be transmitted to the communication device (240) in an SMS message. It should be noted that the single-use payment credential is not transmitted from the remotely accessible server (210) to the issuing financial entity (222). In some embodiments, the remotely accessible server (210) may transmit a first part of the single-use payment credential to the communication device (240) of the consumer in a first message and a second part of the single-use payment credential to the communication device (240) of the consumer in the second, separate message which may follow a few moments (e.g. a few seconds or minutes) later.

The acquiring financial entity (232) may be any appropriate financial institution operable to act as an acquirer to the merchant (260). Embodiments further provide for the remotely accessible server (210) to be in communication with the acquiring financial entity (232), via the payment processing network (270), and for the remotely accessible server (210) to be configured to receive a transaction request, which includes the single-use payment credential, from the acquiring financial entity (232). In some embodiments of the invention, the transaction request further includes the verification value. The transaction request may further include a transaction value, product information, financial account information of a merchant from whom the transaction request originates, or the like.

In response to receiving the transaction request which includes the single-use payment credential and the verification value, the remotely accessible server (210) may use the received single-use payment credential to query the database (214) to obtain the consumer identifier associated with the single-use payment credential and to compare the received verification value with a verification value stored in the database (214) in association with the consumer identifier so as to authenticate the transaction request. If the two verification values do not match, the transaction may be declined.

If the verification values do match, the remotely accessible server may be further configured to transmit an indication of the transaction request in respect of the consumer identifier to the issuing financial entity (222) such that the financial transaction may be completed.

The communication device (240) may be operated by a consumer (242) and may be one or more of the group of: a mobile phone, a smart phone, a feature phone, a wearable computing device, a tablet computer, a personal digital assistant, a satellite phone or the like. The communication device (240) may be addressable using the consumer identifier (e.g. an MSISDN). In other embodiments, remotely accessible server (210) and/or issuer processor (220) may include a routing directory which may provide a communication address of a communication device (240) corresponding to the consumer identifier.

In some embodiments, a mobile software application or other suitable computer program product may be resident in and installed on the communication device (240) which, when executed, may cause a processing circuit of the communication device (240) to receive input from the consumer or display messages or indications to the consumer. Exemplary applications include Java™ applications, SIM Application Toolkit (STK), smartphone applications or the like. In other embodiments, the communication device (240) may be configured to establish a communication channel with the remotely accessible server (210) via which the consumer (242) may provide input or receive messages or indications. Exemplary communication channels include USSD, IVR, a telephone call or the like. In such embodiments, at least some processing may be performed by the remotely accessible server (210), with the communication device (240) acting to a larger extent as an input/output interface to the remotely accessible server (210).

The communication device (240) may be configured to transmit a registration request to the issuing financial entity (222) and to receive a verification value from the remotely accessible server (210). The communication device (240) may be configured to store the verification value for later use. The communication device (240) may be further configured to transmit a request for a single-use payment credential to the issuing financial entity (222) and to receive a single-use payment credential from the remotely accessible server (210).

The merchant (260) may have an appropriate point-of-sale infrastructure which may include a point of sales device, a merchant communication device or the like which may enable the merchant (260) to communicate with the acquiring financial entity (232). The merchant (260) may be able to receive a single-use payment credential presented to the merchant (260) by the consumer (242) and to transmit a transaction request including the single-use payment credential to the acquiring financial entity (232). In some embodiments the merchant (260) may also receive the verification value from the consumer (242) which the merchant may then include in the transaction request transmitted to the acquiring financial entity (232).

The acquiring financial entity (232) may be in communication with the merchant (260) to enable the acquiring financial entity (232) to receive a transaction request including the single-use payment credentials from the merchant (260). The acquiring financial entity (232) may also be in communication with the gateway entity (212), possibly via a payment processing network (270), to enable the acquiring financial entity (232) to transmit the transaction request including the single-use payment credentials from the merchant (260) and to transmit the transaction request including the single-use payment credentials. In some embodiments of the invention, the transaction request may include the verification value provided to the merchant (260) by the consumer (242).

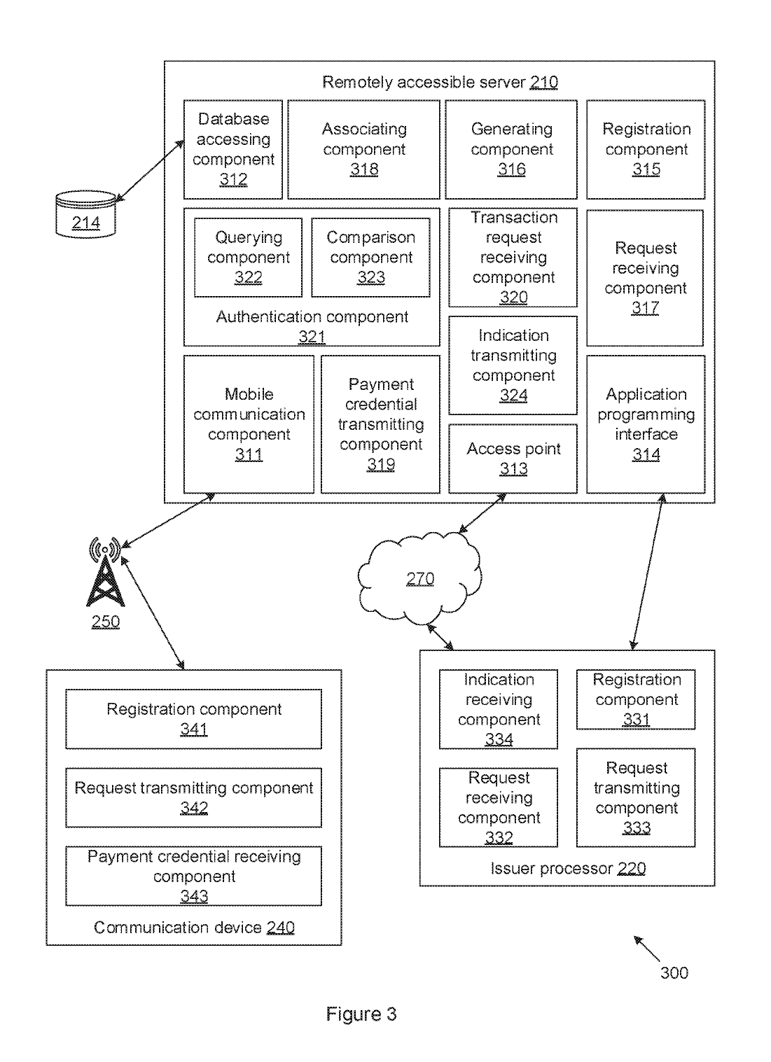

FIG. 3 is a block diagram which illustrates components of devices of a system (300) according to embodiments of the invention.

The system (300) includes a remotely accessible server (210) which may have a mobile communication component (311) which enables the remotely accessible server (210) to communicate with the communication device (240) via the mobile communication network (250). The mobile communication component (311) may provide one or more of: a SMS, USSD, and an xHTML channel configured for inbound and/or outbound communication with the communication device (240).

The remotely accessible server (210) may also include a database accessing component (312) for accessing the database (214). The database accessing component (312) may be able to store data and/or information in the database (214), associate data and/or information stored in the database (214) with database records (e.g. consumer records) and retrieve data and/or information from the database (214).

The remotely accessible server (210) may further include an access point (313) which provides access to the payment processing network (270).

Additionally, the remotely accessible server (210) may include an application programming interface (314) by way of which the remotely accessible server is able to communicate with the issuer processor (220) via an appropriate network infrastructure, such as the Internet. The application programming interface (314) may, for example, specify a set of functions or routines that enable the issuer processor (220) to transmit requests to the remotely accessible server or otherwise interact with specific components of the remotely accessible server (210).

The remotely accessible server (210) may include a registration component (315) receiving a consumer registration request from an issuing financial entity and associating the consumer identifier with a verification value. The registration request may include a consumer identifier which, in some embodiments, may be a phone number of the consumer's communication device. The registration request may also include details pertaining to the issuing financial institution which in some cases may include a bank identification number of the issuing financial entity or any other appropriate routing information.

The registration component (315) may utilise a generating component (316) to generate the verification value. The verification value may be similar to a ‘card verification value’ used in the payment card industry (e.g. a randomly generated three digit number) and may provide an additional layer of security when used in conjunction with a single-use payment credential. The registration component (315) may use the database accessing component (312) to associate the consumer identifier, the verification value and details pertaining to the issuing financial institution with a consumer record stored in the database (214). The registration component (315) may also transmit, using the mobile communication component (311), the verification value to the communication device (240) of the consumer.

The remotely accessible server (210) may further include a request receiving component (317) for receiving, from the issuer processor (220) of issuing financial entity, a request for a single-use payment credential. The request may be received via the application programming interface (314) and may include the consumer identifier of the consumer.

The remotely accessible server (210) may also include an associating component (318) for, responsive to receiving the request, associating the consumer identifier with a single-use payment credential. In doing so, the remotely accessible server (210) may utilise the generating component (316) to generate a single-use payment credential. In one exemplary scenario, the single-use payment credential may be a single-use PAN, although it should be appreciated that the single-use payment credential may be in any appropriate form. In some cases, the single-use payment credential may be graphically represented, such as in a barcode or the like. The remotely accessible server (210) may further utilise the database accessing component (312) for associating the single-use payment credential with the consumer record and in turn the verification value and consumer identifier.

The remotely accessible server (210) may also include a payment credential transmitting component (319) for transmitting the single-use payment credential to the communication device (240) of the consumer. The payment credential transmitting component (319) may transmit the single-use payment credential to the communication device of the consumer using the mobile communication component (311). The single-use payment credential may be transmitted to the consumer in an SMS message, a data message (e.g. an instant messaging (IM) message), a USSD message or the like. The single-use payment credential is not transmitted to the issuing financial entity but is rather sent directly (via a mobile communication network (250)) to the communication device (240) of the consumer.

Furthermore, the remotely accessible server (210) may include a transaction request receiving component (320) for receiving a transaction request including the single-use payment credential from an acquiring financial entity. The transaction request may include the verification value and other particulars relating to the transaction (e.g. a value of the transaction, merchant information, etc.). The transaction request may be received via the payment processing network (270) and the access point (313) and may have been transmitted from the acquiring financial entity responsive to the consumer having presented the single-use payment credential to a merchant in the way of conducting a transaction. In some cases, for example, the single-use payment credential may have a bank identification number (BIN) which enables the payment processing network (270) to route the transaction request to the remotely accessible server (210) for further processing. In other cases, the payment processing network (270) may be able to identify that the transaction request should be sent to the remotely accessible server in another way.

The remotely accessible server (210) may also include an authentication component (321) for authenticating the received single-use payment credential. The authentication component (321) may include a querying component (322) for querying the database (214) using the received single-use payment credential to obtain the consumer identifier associated with the single-use payment credential. The associating component (321) may also include a comparing component (323) for comparing the received verification value with a verification value stored in the database in association with the consumer identifier so as to authenticate the transaction request. In some embodiments, the authentication component (321) may also retrieve actual payment credentials of the consumer which are associated with the consumer record in the database (214), while in other embodiments, the associating component retrieves the consumer identifier.

The remotely accessible server (210) may further include an indication transmitting component (324) for transmitting an indication of the transaction request in respect of the consumer identifier to the issuing financial entity such that the financial transaction may be completed. The indication may include the consumer identifier and other particulars relating to the transaction, or in other cases, actual payment credentials of the consumer, and may be transmitted via the access point (313) and payment processing network (270) or alternatively via the application programming interface (314) over another appropriate network infrastructure.

The system (300) may further include an issuer processor (220) which may be maintained or operated by an issuing financial entity and which may have a registration component (331) for receiving a consumer registration request from a communication device (340) and transmitting the registration request to the remotely accessible server (210). The registration request may include a consumer identifier and details pertaining to the issuing financial institution. The registration request may be transmitted via an appropriate network infrastructure, such as the Internet.

The issuer processor (220) may include a request receiving component (332) for receiving, from the communication device (240), a request for a single-use payment credential. The request may include a consumer identifier of a consumer. The issuer processor (220) may further include a request transmitting component (333) for transmitting the request for a single-use payment credential to the remotely accessible server (210). In addition, the issuer processor (220) may include an indication receiving component (324) for receiving an indication of the transaction request in respect of the consumer identifier from the remotely accessible server (210). The indication may include the consumer identifier and detail of the transaction and may be received via the payment processing network (270). Responsive to receiving the request, the issuing financial entity may be able to process the transaction to completion, for example, by performing settlement with the acquiring financial institution.

Embodiments further provide for the system (300) to include communication device (240) which may include a registration component (341) for transmitting a consumer registration request to the issuing financial entity and receiving the verification value from the remotely accessible server (210). The registration component (341) may transmit the request using a SMS, USSD, IM or any other appropriate message may include the consumer identifier in the request. Similarly, the verification value may be received in a SMS, USSD, IM or any other appropriate message.

The communication device (240) may have a request transmitting component (342) for transmitting a request for a single-use payment credential to the issuing entity and a payment credential receiving component (343) for receiving the single-use payment credential from the remotely accessible server (210). Once again, the request for a single-use payment credential may be transmitted, and the single-use payment credential may be received by way of SMS, USSD, IM or any other appropriate messaging.

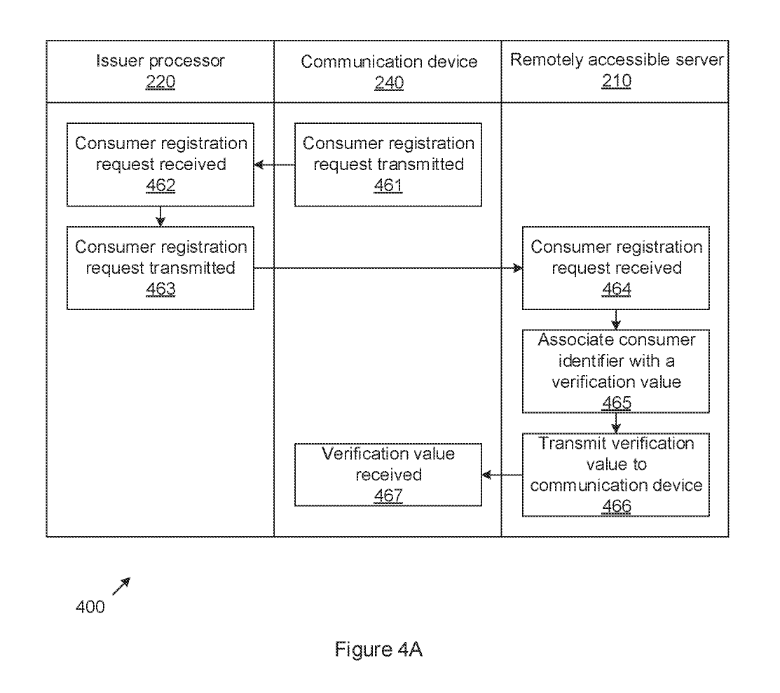

FIGS. 4A and 4B are swim-lane flow diagrams which illustrate methods (400, 401) according to embodiments of the invention. The Figures illustrate steps which are performed by the remotely accessible server (210), the issuer processor (220), an acquirer processor (230), a communication device (240) of a consumer, and a merchant (260). Respective swim-lanes illustrate methods conducted at respective devices or entities.

FIG. 4A illustrates a method (400) for providing a single-use payment credential including initial registration steps according to embodiments of the invention. In an initial registration step (461), a consumer registration request may be transmitted from the communication device (240) to the issuer processor (220). The registration request may include a consumer identifier. The consumer identifier may be one of the group of: a mobile phone number, a mobile subscriber integrated services digital network-number (MSISDN), international mobile subscriber identity (IMSI), an email address, an identity number of the consumer, a username, an alpha-numeric sequence unique to the consumer or the like. The consumer registration request may be received at the issuer processor (220) in a next registration step (462) and may be transmitted from the issuer processor (220) to the remotely accessible server (210) in a following registration step (463).

The remotely accessible server (210) may receive the consumer registration request from the issuer processor (220) in a next registration step (464). The registration request may include a consumer identifier. In a following registration step (465), the remotely accessible server (210) associates the consumer identifier with a verification value and, in a next step (466), transmits the verification value to the communication device (240) of the consumer. The verification value may be a card verification value (CVV) or other appropriate numeric, alphabetical, alpha-numeric, or character sequence.

The verification value is received by the communication device (240) of the consumer in a final registration step (467). The verification value may be stored or remembered by the consumer for later use in conducting transactions.

Having received the verification value, the consumer may be able to conduct financial transactions using the communication device (240). FIG. 4B illustrates a method (401) of providing a single-use payment credential including transacting steps according to embodiments of the invention. In a first transacting step (468), the consumer may use the communication device (240) to transmit a request for a single-use payment credential to the issuer processor (220). The request is received at the issuer processor (220) in a next step (469) and is transmitted from the issuer processor (220) to the remotely accessible server (210) in a following step (470). The request includes the consumer identifier of the consumer.

The remotely accessible server (210) receives the request for a single-use payment credential from the issuer processor (220) in a next step (471). The request includes the consumer identifier of the consumer.

In a following step (472), the remotely accessible server (210) associates the consumer identifier with a single-use payment credential. This step (472) may include steps of generating or obtaining a single-use payment credential and associating the generated or obtained single-use payment credential with the consumer identifier in a database.

The remotely accessible server (210) then transmits the single-use payment credential to a communication device (240) of the consumer in a next step (473). This step (473) does not transmit the single-use payment credential to the communication device (240) via the issuing financial entity (220). In some embodiments of the invention, the step (473) of transmitting the single-use payment credential to the communication device (240) of the consumer transmits a first part of the single-use payment credential to the communication device of the consumer in a first message and a second part of the single-use payment credential to the communication device of the consumer in the second message. These two messages may be transmitted to the communication device (240) of the consumer separately.

In another embodiment of the invention, the single-use payment credential may be usable only in combination with a static credential, such as a verification value. In such an embodiment, the step (473) of transmitting the single-use payment credential to the communication device (240) of the consumer transmits the verification value to the communication device (240) of the consumer in a first message and the single-use payment credential to the communication device (240) of the consumer in a second message. These two messages are preferably transmitted to the communication device (240) of the consumer separately.

In a next step (474), the single-use payment credential is received at the communication device (240) and may be presented to the merchant (260). In some embodiments of the invention, the verification value is also presented to the merchant (260). The merchant (260) then transmits, in a next step (475), a transaction request including the single-use payment credential to the acquiring processor (230). The acquiring processor (230) receives the transaction request in a following step (476) and transmits the transaction request to the remotely accessible server (210) in a next step (477).

In a following step (478), the remotely accessible server (210) receives the transaction request including the single-use payment credential from the acquiring processor (230). In some embodiments, the step (478) of step of receiving the transaction request including the single-use payment credential from the acquiring processor (230) further includes receiving the verification value in the transaction request. This step (478) may further include using the received single-use payment credential to query the database to obtain the consumer identifier associated with the single-use payment credential and comparing the received verification value with a verification value stored in a database in association with the consumer identifier so as to authenticate the transaction request.

In a next step (479), the remotely accessible server (210) transmits an indication of the transaction request in respect of the consumer identifier to the issuer processor (220) such that the financial transaction may be completed.

The issuer processor (220) receives the indication of the transaction request in respect of the consumer identifier in a final step (480). Thereafter, the issuer processor (220) may debit or credit, as may be appropriate, a consumer account associated with the consumer identifier and conduct necessary steps in completing the transaction as are known to those skilled in the art.

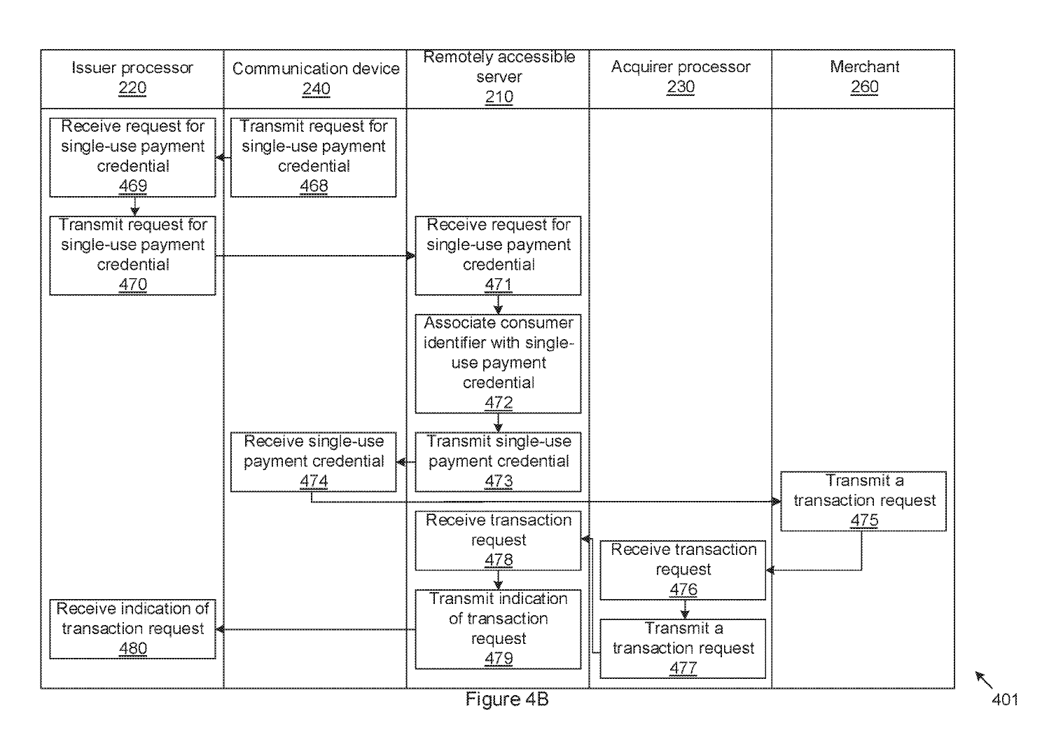

FIG. 5 is a flow diagram which illustrates an example method for providing a single-use payment credential conducted at a remotely accessible server of a gateway entity. The Figure illustrates steps conducted at the remotely accessible server described above with reference to FIG. 4B in greater detail.

At a first stage (502), the remotely accessible server receives the request for a single-use payment credential from an issuer processor of an issuing financial entity. The request includes a consumer identifier of a consumer against whose account the single-use payment credential will be usable. The consumer identifier in this case is usable in addressing communications to a communication device of a consumer (e.g. an MSISDN). The request may be received at the remotely accessible server via an appropriate network infrastructure (e.g. the Internet) and may have been received responsive to the consumer requesting a single-use payment credential from the issuing financial entity.

At a next stage (504), the remotely accessible server generates or otherwise obtains a single-use payment credential. For example, the remotely accessible server may obtain a single-use payment credential from an external service provider or alternatively may generate a single-use payment credential. The single-use payment credential may be any appropriate credential usable in conducting a financial transaction, and may have a time-to-live associated with it.

At a following stage (506), the remotely accessible server associates the single-use payment credential with the consumer identifier in a database. This may include associating the single-use payment credential and consumer identifier with a consumer record in the database, the consumer record having a verification value and other information associated therewith (e.g. details of the issuing financial entity).

The remotely accessible server then transmits the single-use payment credential to a communication device of the consumer via a mobile communication network at a next stage (508). This stage (508) does not transmit the single-use payment credential to the communication device via the issuing financial entity (220) and thus the issuing entity may have no knowledge of the single-use payment credential. In some embodiments, the step (508) of transmitting the single-use payment credential to the communication device of the consumer transmits the verification value to the communication device of the consumer in a first message and the single-use payment credential (e.g. including a single-use PAN, expiry date and other discretionary data) to the communication device of the consumer in the second message. These two messages may be transmitted to the communication device of the consumer separately and at spaced apart points in time. In another embodiment, the consumer may already have the verification value stored in the communication device or otherwise accessible to the consumer, in which case the stage (508) of transmitting the single-use payment credential to the communication device transmits only a single message including, for example, a single-use PAN, expiry date and other discretionary data. In yet another embodiment, the single-use payment credential may split into first and second messages to make unauthorized interception of the single-use payment credential more difficult. It is also anticipated that the first message and second message be transmitted using different protocols. For example, the first message may be transmitted to the communication device using IVR, while the second message may be a SMS.

At a following stage (510), the remotely accessible server receives a transaction request including the single-use payment credential from an acquiring financial entity. The transaction request may include the verification value and other details relating to the transaction and may be received from the acquiring financial entity via a payment processing network.

The remotely accessible server may then, at a next stage (512), query the database using the received single-use payment credential to obtain the consumer identifier associated with the single-use payment credential. The stage (512) of querying the database may also include identifying particulars relating to the issuing financial entity so that a transaction indication can be transmitted to the issuing financial entity.

At a following stage (514), the remotely accessible server may compare the received verification value with a verification value stored in a database in association with the consumer identifier so as to authenticate the transaction request. The remotely accessible server may also verify that the single-use payment credential has not already been used, and may also verify that a time-to-live associated with the single-use payment credential is still valid.

At a next stage (516), the remotely accessible server transmits an indication of the transaction request in respect of the consumer identifier to the issuer processor of the issuing financial entity such that the financial transaction may be completed. The indication may be transmitted via the payment processing network or alternatively via another appropriate network infrastructure and may include details relating to the transaction and may include the detail relating to the transaction.

Embodiments of the present invention described above with reference to the figures provide systems methods and devices for providing a single-use payment credential usable in a financial transaction. The invention provides a remotely accessible server which may be maintained or operated by a gateway entity and which may have a mobile communication component which may enable the remotely accessible server to communicate with a communication device of a consumer.

By maintaining or operating a remotely accessible server with a mobile communication component, the gateway entity may be operable to generate or obtain single-use payment credentials and to transmit the single-use payment credential to the communication device of the consumer. The single-use payment credential may be transmitted to the communication device without going via an issuing financial entity.

Thus, embodiments provide systems, methods and devices which may alleviate the burden imposed on an issuing financial entity to implement data protection standards such as those advocated by PCI DSS. This may be particularly beneficial to issuing financial institutions providing a mobile banking facility (for example a mobile network operator who would not ordinarily meet PCI DSS requirements).

Embodiments further provide systems methods and devices which may mitigate fraudulent use of single-use payment credentials by unscrupulous third parties. By requiring a verification value when using single-use payment credentials, for example, a miscreant intercepting single-use payment credentials being transmitted from a gateway entity to a communication device may not be able make use of the single-use payment credentials as the miscreant would not have been able to intercept the verification value.

Thus by transmitting the verification value separately from, and at a different time to, the single-use payment credential with which it is to be used, the opportunity for an unauthorized third party to intercept a full payment credential usable in completing a fraudulent transaction is reduced.

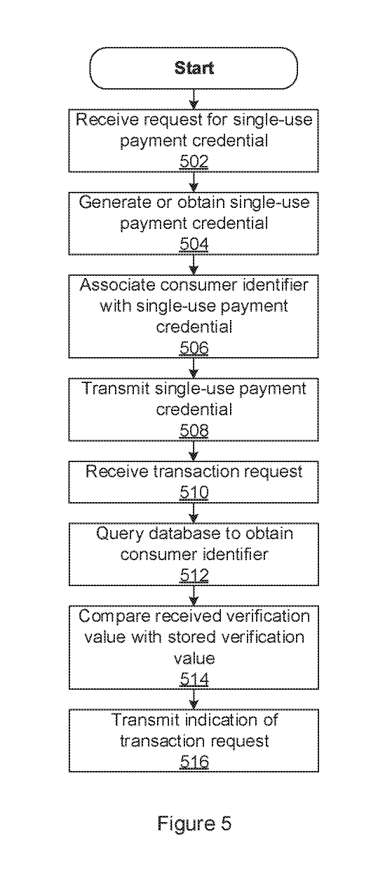

FIG. 6 illustrates one example of a mobile communication network (600) coupling, for example, a communication device (240) of a consumer with a remotely accessible server (210) of a gateway entity through a USSD/GPRS Gateway (607). The network (600) includes a Mobile Station (MS) (620A) such as a consumer's communication device (240), or any equipment or software needed to communicate with a mobile communication network operated by a Mobile Network Operator. The Mobile Network Operator may include a Base Station Subsystem (BSS) (620B). The BSS is a section of a traditional mobile telephone network which is responsible for handling traffic and signalling between a communication device and the network switching subsystem. The BSS (620B) may carry out transcoding of speech channels, allocation of radio channels to communication devices, paging, transmission and reception over the air interface, and many other tasks related to radio networks and other communications networks. The BSS (620B) may comprise Base Transceiver Stations (630A) and (630B), or BTS, which contains the equipment for transmitting and receiving radio signals (transceivers), antennas, and equipment for encrypting and decrypting communications with the base station controller (BSC). For example, the BTS (630A) and (630B) may be towers scattered through a region to provide mobile communications service coverage over the region over several different frequencies.

BTS (630A) and (630B) are controlled by a parent Base Station Controller (BSC) (632). The base station controller (BSC) provides the intelligence behind the BTSs. Typically, a BSC has tens or even hundreds of BTSs under its control. The BSC handles allocation of radio channels, receives measurements from the communication devices, and controls handovers from BTS (630A) to BTS (630B) (except in the case of an inter-BSC handover in which case control is in part the responsibility of the anchor Mobile Switching Centre (640)). A function of the BSC is to act as a concentrator where many different low capacity connections to BTSs (with relatively low utilization) become reduced to a smaller number of connections towards the Mobile Switching Centre (MSC) (640) (with a high level of utilization). Overall, this means that networks are often structured to have many BSCs (632) distributed into regions near their BTSs (630A) and (630B) which are then connected to large centralized MSC sites (640) in the Network Sub-System (NSS) (607A) in the USSD/GPRS Gateway (607).

For GPRS (general packet radio service), the BSC (632) may be coupled to a Packet Control Unit (PCU) (634). The PCU (634) performs some of the processing tasks of the BSC (632), but for radio packet data. The allocation of channels between voice and data is controlled by the BSS (620B), but once a channel is allocated to the PCU, the PCU takes full control over that channel. The PCU can be built into the BSS, built into the BSC, or even, in some proposed architectures, it can be at the SGSN (Serving GPRS Support Node) site (636). In most cases, the PCU (634) is a separate node communicating extensively with the BSC (632) on the radio side and the SGSN (636) on the GPRS core network (607B) side in the USSD/GPRS Gateway (607).

The Network Subsystem (NSS) (607A) processes USSD protocol in standard GSM operation. The Mobile Switching Centre (640) may also include a Visitor Locator Register (VLR), which locates another subscriber's communication device connecting through a Mobile Network Operator's BTS (e.g., tower). For example, the VLR would locate the location of a Verizon user if the Verizon user was connecting to an AT&T tower. An extension of the Mobile Switching Centre (640) may also include a Public Switched Telephone Network (PSTN) (640A), which is a network of the world's public circuit-switched telephone networks. It consists of telephone lines, fibre optic cables, microwave transmission links, cellular networks, communications satellites, and undersea telephone cables, all inter-connected by switching centres, thus allowing any telephone in the world to communicate with any other. Originally a network of fixed-line analogue telephone systems, the PSTN (640A) is now almost entirely digital in its core and includes mobile as well as fixed telephones.

The MSC/VLR (640) may be in communication with a SS7 Network/MAP (642). Signalling System No. 7 (SS7) is a set of telephony signalling protocols which are used to set up most of the world's public switched telephone network telephone calls. The main purpose is to set up and tear down telephone calls. Other uses include number translation, local number portability, prepaid billing mechanisms, short message service (SMS), and a variety of other mass market messaging and communications services. The SS7 Network may also include a Mobile Application Part (MAP), which is an SS7 protocol which provides an application layer for the various nodes in GSM and UMTS mobile core networks and GPRS core networks to communicate with each other in order to provide services to mobile phone users.

The Mobile Application Part (MAP) (642) is the application-layer protocol used to access the Home Location Register (HLR) (644), Visitor Location Register (VLR) and Mobile Switching Centre (MSC) (640), Equipment Identity Register (EIR) (644), Authentication Centre (AUC) (644), Short message service centre and Serving GPRS Support Node (SGSN) (636). The Home Location Register (HLR) (644), in conjunction with the EIR and AUC (also in 744), would locate and identify a user communication device, for example, detecting and identifying an AT&T user connecting to an AT&T BTS (e.g., tower).

To perform the tasks and communicate with the entities described above, the SS7 Network/MAP (642), or the USSD Gateway Network Sub-System (NSS) (607A), may include a SS7 stack (642A), a MAP module (642B), a Session Manager (642C), a Locator Module (642D), a Logger Module (642E), and a Database Server (642F). Certain data elements transmitted in mobile messages (e.g., SMS, USSD) may be stored in the Logger Module (642E) and the Database Server (642F). Thus, anyone within the mobile communication network with access to the USSD Gateway (607), specifically the NSS (607A), may have access to messages, and in turn, stored data elements transmitted in the messages and logged in the gateway. However, there are controls to reduce the potential of data elements from SMS messages being compromised. Examples of such security controls include, but are not limited to, access to an associated SIM (Subscriber Identity Module), limits on transaction size or frequency, etc.

The USSD/GPRS Gateway (607) may also include a GPRS core network (607B). The GPRS core network (607B) is a central part of the General Packet Radio Service which allows 2G, 3G, and WCDMA (wideband CDMA) mobile networks to transmit IP packets to external networks such as the Internet. The GPRS core network (607B) can be an integrated part of the GSM network switching subsystem, and includes a network of GPRS support nodes (GSN). A GSN is a network node which supports the use of GPRS in the GSM core network. There can be two GSNs, namely Gateway GPRS Support Node (GGSN) (646) and Serving GPRS Support Node (636), which are communicatively connected by a GPRS backbone IP Network (638).

The Gateway GPRS Support Node (GGSN) (646) can be a main component GPRS code network (607B). The GGSN (646) is responsible for the interworking and routing between the GPRS IP network (638) and external packet switched networks, like the Internet (670) and other communications networks. From an external network's point of view, the GGSN (646) is a router to a sub-network GPRS backbone IP Network (638). When the GGSN (646) receives data addressed to a specific user, it checks if the user is active. If it is, the GGSN (646) forwards the data to the Serving GPRS Support Node (SGSN) (636) serving the mobile user through the GPRS backbone IP Network (638), but if the mobile user is inactive, the data is discarded. On the other hand, mobile-originated packets from the SGSN (636), through the GPRS backbone IP Network (638), are routed by the GGSN (646) to the right external network, such as the Internet (670). The GGSN (646) is the anchor point that enables the mobility of the user terminal in the GPRS IP networks (638) to connect to an external network, such as the Internet (670).

Serving GPRS Support Node (SGSN) (636) can be responsible for the delivery of data packets from and to the mobile stations (620A) within a geographical service area. Its tasks include packet routing and transfer, mobility management (attach/detach and location management), logical link management, and authentication and charging functions. The location register of the SGSN (636) stores location information (e.g., current VLR), and user profiles (e.g., IMSI, address(es) used in the packet data network) of all GPRS users registered with the SGSN (636).

The USSD/GPRS Gateway (607) may be in communication with an Application Server (670). The Application Server may be operated on the remotely accessible server (210), or may be included in the USSD/GPRS Gateway (607). The Application Server may include a Billing Server. Some MNO's do not have their USSD Gateway connected to the Billing Server, however with the rise in conducting transactions using communication devices, USSD Gateways may now be connected to the billing sever operated on the application server (670).

The remotely accessible server (210) may include a consumer account mobile interface and an access point. The remotely accessible server (210) may also include an application server (670). The remotely accessible server (210) may include a non-transitory computer readable medium that includes instructions for generating transaction request messages and transaction response messages. In some embodiments, remotely accessible server (210) can be part of payment processing network server computer. The remotely accessible server (210) may also include an Access Point (AP) or payment processing network interface, which provides access to a payment processing network.

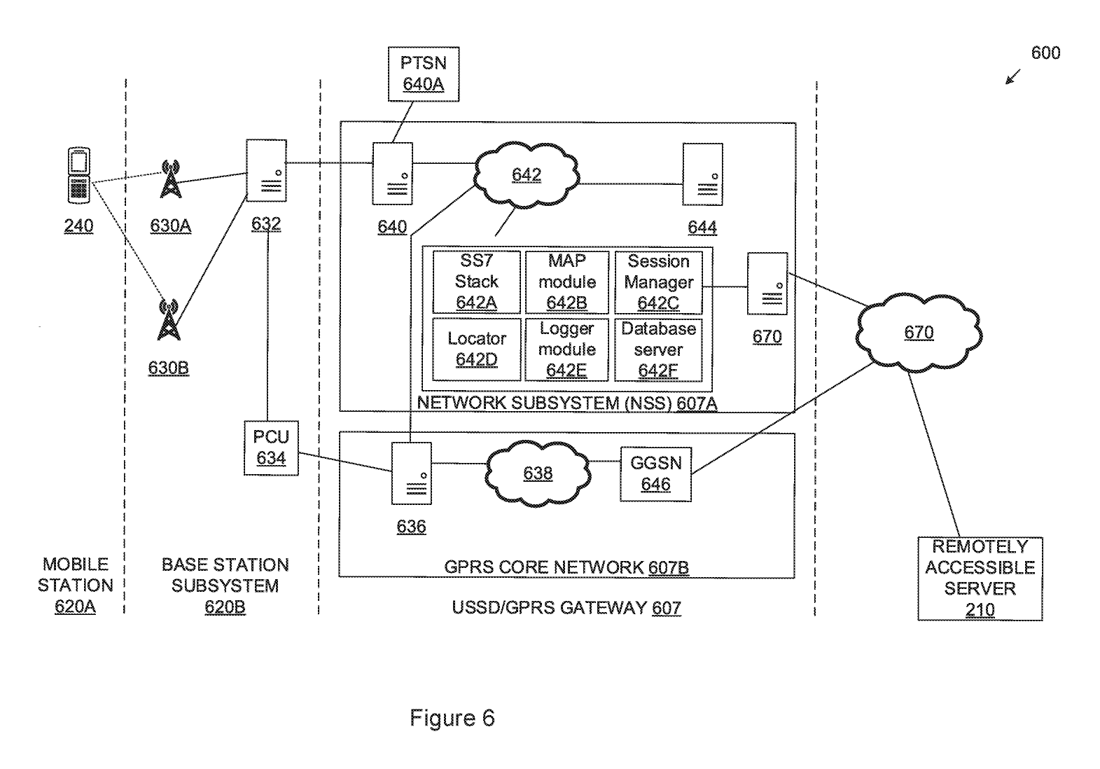

FIG. 7 illustrates an example of a computing device (700) in which various aspects of the disclosure may be implemented. The computing device (700) may be suitable for storing and executing computer program code. The various participants and elements in the previously described system diagrams may use any suitable number of subsystems or components of the computing device (700) to facilitate the functions described herein.

The computing device (700) may include subsystems or components interconnected via a communication infrastructure (705) (for example, a communications bus, a cross-over bar device, or a network). The computing device (700) may include at least one central processor (710) and at least one memory component in the form of computer-readable media.

The memory components may include system memory (715), which may include read only memory (ROM) and random access memory (RAM). A basic input/output system (BIOS) may be stored in ROM. System software may be stored in the system memory (715) including operating system software.

The memory components may also include secondary memory (720). The secondary memory (720) may include a fixed disk (721), such as a hard disk drive, and, optionally, one or more removable-storage interfaces (722) for removable-storage components (723).

The removable-storage interfaces (722) may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces (722) may also be in the form of ports or sockets for interfacing with other forms of removable-storage components (723) such as a flash memory drive, external hard drive, or removable memory chip, etc.

The computing device (700) may include an external communications interface (730) for operation of the computing device (700) in a networked environment enabling transfer of data between multiple computing devices (700). Data transferred via the external communications interface (730) may be in the form of signals, which may be electronic, electromagnetic, optical, radio, or other types of signal.

The external communications interface (730) may enable communication of data between the computing device (700) and other computing devices including servers and external storage facilities. Web services may be accessible by the computing device (700) via the communications interface (730).

The external communications interface (730) may also enable other forms of communication to and from the computing device (700) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (710).

A computer program product may be provided by a non-transient computer-readable medium, or may be provided via a signal or other transient means via the communications interface (730).

Interconnection via the communication infrastructure (705) allows a central processor (710) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, joystick, or the like) may couple to the computing device (700) either directly or via an I/O controller (735). These components may be connected to the computing device (700) by any number of means known in the art, such as a serial port.

One or more monitors (745) may be coupled via a display or video adapter (740) to the computing device (700).

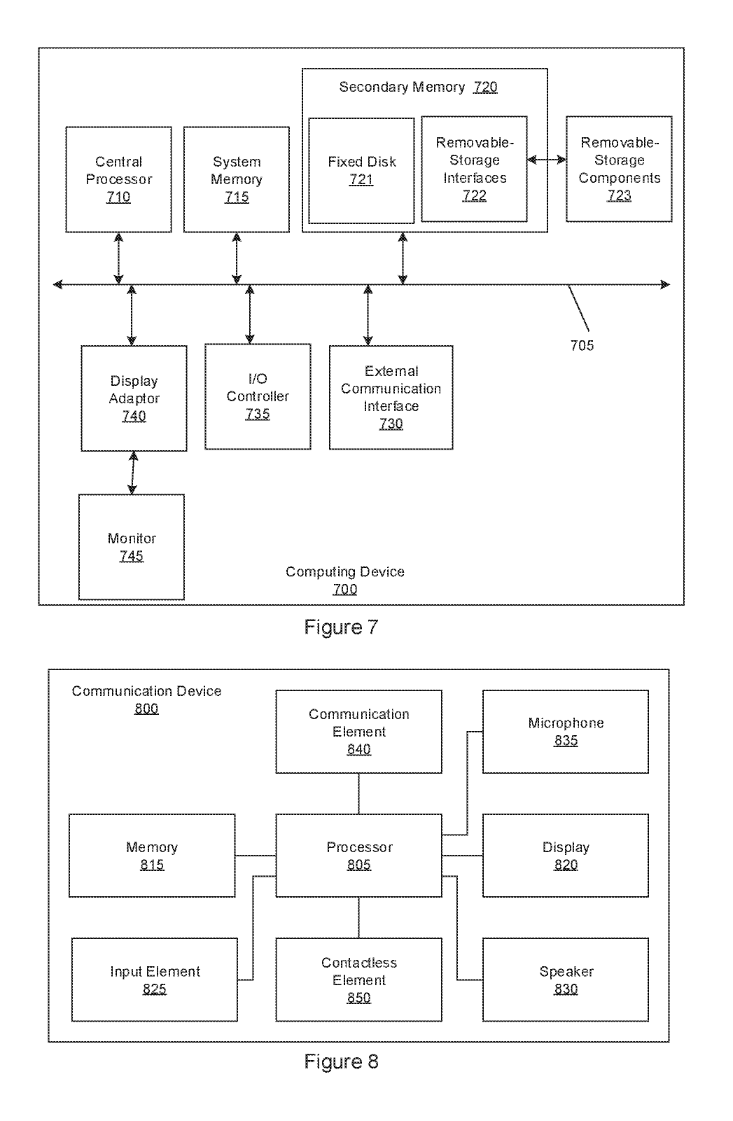

FIG. 8 shows a block diagram of a communication device (800) that may be used in embodiments of the disclosure. The communication device (800) may be a cell phone, a feature phone, a smart phone, a satellite phone, or a computing device having a phone capability.

The communication device (800) may include a processor (805) (e.g., a microprocessor) for processing the functions of the communication device (800) and a display (820) to allow a user to see the phone numbers and other information and messages. The communication device (800) may further include an input element (825) to allow a user to input information into the device (e.g., input buttons, touch screen, etc.), a speaker (830) to allow the user to hear voice communication, music, etc., and a microphone (835) to allow the user to transmit his or her voice through the communication device (800).

The processor (810) of the communication device (800) may connect to a memory (815). The memory (815) may be in the form of a computer-readable medium that stores data and, optionally, computer-executable instructions.

The communication device (800) may also include a communication element (840) for connection to communication channels (e.g., a cellular telephone network, data transmission network, Wi-Fi network, satellite-phone network, Internet network, Satellite Internet Network, etc.). The communication element (840) may include an associated wireless transfer element, such as an antenna.

The communication element (840) may include a subscriber identity module (SIM) in the form of an integrated circuit that stores an international mobile subscriber identity and the related key used to identify and authenticate a subscriber using the communication device (800). One or more subscriber identity modules may be removable from the communication device (800) or embedded in the communication device (800).

The communication device (800) may further include a contactless element (850), which is typically implemented in the form of a semiconductor chip (or other data storage element) with an associated wireless transfer element, such as an antenna. The contactless element (850) may be associated with (e.g., embedded within) the communication device (800) and data or control instructions transmitted via a cellular network may be applied to the contactless element (850) by means of a contactless element interface (not shown). The contactless element interface may function to permit the exchange of data and/or control instructions between mobile device circuitry (and hence the cellular network) and the contactless element (850).

The contactless element (850) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the communication device (800) and an interrogation device. Thus, the communication device (800) may be capable of communicating and transferring data and/or control instructions via both a cellular network and near field communications capability.

The data stored in the memory (815) may include: operation data relating to the operation of the communication device (800), personal data (e.g., name, date of birth, identification number, etc.), financial data (e.g., bank account information, a bank identification number (BIN), credit or debit card number information, account balance information, expiration date, loyalty provider account numbers, etc.), transit information (e.g., as in a subway or train pass), access information (e.g., as in access badges), etc. A user may transmit this data from the communication device (800) to selected receivers.

The communication device (800) may be, amongst other things, a notification device that can receive alert messages and access reports, a portable merchant device that can be used to transmit control data identifying a discount to be applied, as well as a portable consumer device that can be used to make payments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

1. A method of providing a single-use payment credential usable in a financial transaction, the method conducted at a remotely accessible server comprising the steps of:
receiving, from an issuing financial entity, a request for a single-use payment credential, the request including a consumer identifier of a consumer;
associating, in a database, the consumer identifier with a single-use payment credential;
transmitting the single-use payment credential to a communication device of the consumer for presentation to a merchant;
receiving, from an acquiring financial entity, a transaction request including the single-use payment credential; and,
transmitting an indication of the transaction request in respect of the consumer identifier to the issuing financial entity such that the financial transaction may be completed.

2. The method as claimed in claim 1, wherein the step of receiving a request for a single-use payment credential is responsive to the issuing financial entity receiving, from a communication device of a consumer, a request for a single-use payment credential.

3. The method as claimed in claim 1, wherein the single-use payment credential is usable only in combination with a verification value and wherein the step of transmitting the single-use payment credential to a communication device of the consumer transmits the verification value to the communication device of the consumer in a first message and the single-use payment credential to the communication device of the consumer in a second message, and wherein the first and second message are transmitted to the communication device of the consumer separately.

4. The method as claimed in claim 1, wherein the step of associating the consumer identifier with a single-use payment credential includes steps of:
generating or obtaining a single-use payment credential; and,
associating the generated or obtained single-use payment credential with the consumer identifier in a database.

5. The method as claimed in claim 1, wherein the step of receiving a transaction request including the single-use payment credential from an acquiring financial entity further includes receiving a verification value in the transaction request.

6. The method as claimed in claim 5, wherein the step of receiving a transaction request including the single-use payment credential and the verification value from the acquiring financial entity includes steps of:
using the received single-use payment credential to query the database to obtain the consumer identifier associated with the single-use payment credential; and,
comparing the received verification value with a verification value stored in the database in association with the consumer identifier so as to authenticate the transaction request.

7. The method as claimed in claim 1, wherein the method includes initial registration steps of:
receiving a consumer registration request from an issuing financial entity, the registration request including a consumer identifier;
associating the consumer identifier with a verification value; and,
transmitting the verification value to the communication device of the consumer.

8. The method as claimed in claim 7, wherein the verification value is static.

9. A system for providing a single-use payment credential usable in a financial transaction, the system comprising a remotely accessible server including:
a request receiving component for receiving, from an issuing financial entity, a request for a single-use payment credential, the request including a consumer identifier of a consumer;
an associating component for associating, in a database, the consumer identifier with a single-use payment credential;
a payment credential transmitting component for transmitting the single-use payment credential to a communication device of the consumer for presentation to a merchant;
a payment credential receiving component for receiving, from an acquiring financial entity, a transaction request including the single-use payment credential; and,
an indication transmitting component for transmitting an indication of the transaction request in respect of the consumer identifier to the issuing financial entity such that the financial transaction may be completed.

10. The system as claimed in claim 9, wherein the system further includes an issuer processor maintained or operated by an issuing entity and having:
a receiving component for receiving, from the communication device, a request, including a consumer identifier, for a single-use payment credential;
a transmitting component for transmitting the request for a single-use payment credential to the remotely accessible server; and,
an indication receiving component for receiving an indication of the transaction request in respect of the consumer identifier from the remotely accessible server.

11. The system as claimed in claim 9, wherein the system further includes a communication device having:
a request transmitting component for transmitting a request for a single-use payment credential to the issuing entity; and,
a payment credential receiving component for receiving the single-use payment credential from the remotely accessible server.

12. The system as claimed in claim 9, wherein the remotely accessible server further includes a generating component for generating or obtaining a single-use payment credential, and wherein the associating component is for associating the generated or obtained single-use payment credential with the consumer identifier in a database.

13. The system as claimed in claim 9, wherein the payment credential receiving component receives, from an acquiring financial entity, a transaction request including the single-use payment credential and a verification value.

14. The system as claimed in claim 13, wherein the remotely accessible server further includes:
a querying component for querying the database using the received single-use payment credential to obtain the consumer identifier associated with the single-use payment credential; and,
a comparing component for comparing the received verification value with a verification value stored in the database in association with the consumer identifier so as to authenticate the transaction request.

15. The system as claimed in claim 9, wherein the system includes a registration component for: receiving a consumer registration request from an issuing financial entity, the registration request including a consumer identifier; associating the consumer identifier with a verification value; and, transmitting the verification value to the communication device of the consumer.

16. The system as claimed in claim 15, wherein the verification value is static.

17. The system as claimed in claim 9, wherein the remotely accessible server includes a mobile communication component which enables the remotely accessible server to communicate with the communication device via a mobile communication network, and wherein the payment credential transmitting component transmits the single-use payment credential to a communication device of the consumer via the mobile communication component.

18. A computer program product for providing a single-use payment credential usable in a financial transaction, the computer program product comprising a computer-readable medium having stored computer-readable program code for performing the steps of:
receiving, from an issuing financial entity, a request for a single-use payment credential, the request including a consumer identifier of a consumer;
associating, in a database, the consumer identifier with a single-use payment credential;
transmitting the single-use payment credential to a communication device of the consumer for presentation to a merchant;
receiving, from an acquiring financial entity, a transaction request including the single-use payment credential; and,
transmitting an indication of the transaction request in respect of the consumer identifier to the issuing financial entity such that the financial transaction may be completed.
